(19) United States
(12) Patent Application Publication
(10) Pub. No.: US 2015/0274918 A1
(43) Pub. Date: Oct. 1, 2015

(54) MULTICOMPONENT SYSTEM FOR PRODUCTION OF ALKOXYSILANE-BASED SPRAY FOAMS

(71) Applicant: BAYER MATERIALSCIENCE AG, Leverkusen (DE)

(72) Inventors: Jürgen Köcher, Langenfeld (DE); Carina Bodenröder, Cologne (DE); Dennis Hansson, Gunnilse (SE)

(21) Appl. No.: 14/437,665

(22) PCT Filed: Oct. 21, 2013
(86) PCT No.: PCT/EP2013/071949

§ 371 Date: Apr. 22, 2015

(30) Foreign Application Priority Data
Oct. 24, 2012 (EP) 12189727.6

(51) Int. Cl. C08J 9/12; B01J 19/26

(52) U.S. Cl. CPC C08J 9/125; B01J 19/26; C08J 2203/10; C08J 2383/08; B01J 2219/24

(57) ABSTRACT

Disclosed herein is a multicomponent system comprising at least two separate components A and B, component A containing an alkoxysilane-terminated prepolymer and component B containing a mixture comprising a component B1 containing water and a component B2 containing a polyol having at least two OH-groups and a molar mass from >62 to <500 g/mol, where the proportion of component B2 in component B is from >20% by weight to <80% by weight. Also disclosed herein is a multichamber pressurized can comprising a multicomponent system as disclosed herein, and to a shaped body obtainable by polymerizing the multicomponent system disclosed herein.

The present invention relates to a multi-component system comprising at least two separate components A and B, a multi-chamber pressure cell containing a multi-component system in accordance with the invention, as well as a shaped body, obtainable by polymerization of the multi-component system of to the invention.

Sprayable multi-component systems are known from the prior art. Thus, there are sprayable expanding foams that are used for filling cavities, for example in the construction sector. They are used, in particular, to fill gaps and cavities between window frames and door frames and the surrounding masonry, possess good moisture insulating properties and good thermal insulation properties. Further areas of applicability for such sprayable multi-component systems are the utilization for the insulation of pipes or the foam filling of cavities in technical devices.

These sprayable systems for technical applications typically consist of a polyisocyanate component and a polyol component. Sprayable systems whose components contain free isocyanate groups are particularly unsuitable for medical applications.

For the above reasons, polymerizable foamable compositions, which do not cure via free isocyanate groups, have been developed in recent years. For example, silicone foams that contain alkoxy-, acyloxy- or oximo-terminated silicone pre-polymers are known from U.S. Pat. No. 6,020,389 A1. These compounds polymerize via a condensation reaction of siloxane groups. A disadvantage of these compounds is their long curing time as they—just as 1 K-polyurethane (1 component polyurethane) spray foams—are dependent on humidity for the polymerization reaction. For thick foam-filled layers, in particular, the completion of the reaction requires a correspondingly long time period. This is not only inconvenient, but also problematic, as the foam structure formed in the spraying process partly collapses, before the pore walls are able to build up sufficient inherent strength through the progressing polymerization reaction.

Alkoxysilane-terminated polyurethane pre-polymers are known from patent applications WO 00/04069 A, WO 2009/007038 A, EP 946 629 A and EP 1 098 920 A. These pre-polymers have a conventional polyurethane backbone, also known as “backbone”, which is obtained in known manner by reacting difunctional isocyanates with polyols. By using an excess of polyfunctional isocyanates, WO 00/04069 A achieves that the respective end groups of the pre-polymer chains possess free isocyanate groups. In a further reaction step, these isocyanate-terminated pre-polymers are then reacted with an aminoalkyltrialkoxysilane to form the desired alkoxysilane-terminated polyurethane pre-polymers. Aminopropyltrimethoxysilane is used, in particular, for this purpose. The pre-polymer obtained therefrom has trimethoxysilane-terminated end groups, which are coupled to the polyurethane backbone via a propylene spacer. Due to the propylene group between the silicon atom and the polyurethane backbone, such silanes are referred to as γ-silanes.

During the curing reaction, when exposed to water, γ-silanes cleave alcohol and form Si—O—Si networks, curing the pre-polymer. Like the isocyanate-terminated polyurethane pre-polymers, γ-silanes have the disadvantage of a relatively slow curing reaction. This disadvantage can only partly be compensated by adding large amounts of cross-linking catalysts to γ-silane based compositions, for example dibutyl tin dilaurate, which is also used for polyurethane pre-polymers. However, in some cases this is detrimental to the storage stability of these compositions.

As even larger amounts of cross-linking catalysts are not capable to completely compensate for the low reactivity of γ-silanes, more reactive compound types were investigated. These are known, for example, from WO 02/066532 A1. The pre-polymers described therein are also silane-terminated polyurethane pre-polymers. The main difference to the γ-silanes described above is the utilization of a methylene spacer instead of a propylene group between the polyurethane backbone and the silicon atom. For this reason, these silanes are also called α-silanes. The shorter distance between the silicon atom and the highly polar urea group of the polyurethane-backbone increases the reactivity of the alkoxy groups located on the silicon atom (α-effect), with the result that the hydrolysis of alkoxysilane groups and the subsequent condensation reaction proceeds with significantly increased speed.

WO 2009/007018 generally describes the use of silane-terminated pre-polymers for the preparation of wound dressings.

Sprayable foams that are based on α- or γ-silane-terminated pre-polymers are suitable, among other applications, for wound treatment applications and are also described in not yet published European patent applications having the application numbers 11183213.5, 11183214.3 and 11183212.7. The silane-terminated pre-polymers are sprayed as fast-curing foams with a designated spraying system, by rapid mixing with an aqueous component in a static mixer and by using a propellant gas. The foams described in the cited patent applications require foam additives, such as silicon, in order to give these foams good water wettability. However, as these additives are not covalently bound to the polymer backbone, they can be washed out of the foam.

Therefore, one object of the present invention was to provide a multi-component system suitable for the production of spray foams, which cure quickly, have a highly porous structure, with a high pore volume and good wettability. Furthermore, the multi-component system, or a spray foam available from this multi-component system, should cover a wide range of applications. In particular, the multi-component system should be useful for medical applications on the skin, such as foamed wound dressings.

This object it is solved, in accordance with the invention, by a multi-component system comprising at least two separate components A and B, wherein component A contains an alkoxy silane-terminated pre-polymer, and component B contains a mixture comprising a component B1, containing water, and a component B2, containing a polyol having at least two OH-groups and a molar mass ≧62 g/mol and ≦500 g/mol, wherein the content of component B2 within component B is >20 wt.-% and ≦80 wt.-%.

Surprisingly, it has been found that an alkoxysilane-terminated pre-polymer can be cured in a short time, using a second component containing a polyol, with the result that such a composition can be filled in a multi-chamber pressure cell and foamed into stable foams with the aid of propellant gases. The high curing speed of the multi-component system of the invention results in the mixture already forming a self-supporting foam structure more or less immediately after foaming, with the result that the foam practically cannot collapse before being completely cured, which usually requires only a few minutes. In other words, the present invention provides a 2K-silane foam system from which polymer foams having a high pore volume can be obtained, without the requirement to use additional gas-evolving reactants such as the combination of calcium carbonate and citric acid. The resulting foams also show a particularly good water wettability. Another advantage is that the hydrophilicity required for the good wettability of the foams is permanent and cannot be washed out as it is the case with additional hydrophilizing additives such as silicon ethers.

The multi-component system of the present invention can be used for a variety of applications. Thus, it is suitable for all application areas in which the aforementioned polyurethane foams and α- and γ-silane foams are proposed, i.e. for the building industry, for insulation of pipes or for filling hollow spaces in machinery.

Surprisingly, it has been also found that the multi-component system of the present invention can also be used in the medical sector, since it does not contain toxic or irritant compounds. The medical application scope includes, for example, the provision of in-situ producible wound dressings.

Another advantage of the multi-component system of the present invention can be seen in case of the above mentioned medical applications as the hardness of the polymer foams can be varied through the choice of the chemical nature and/or the chain length of the polymer backbone of the silane pre-polymers. In addition to the above parameters, the hardness of the foam can be modified by further measures. Thus, very soft and therefore elastic foams or rigid foams with protective properties can be formed. In this regard, the medical application scope is not limited to wound treatment in the narrow/direct meaning, but applications such as the immobilization of limbs, such as broken bones, sprained ligaments, sprains and the like are also possible. In addition, applications in the cosmetic field are also imaginable.

In a preferred embodiment of the invention, component B1 has a pH-value of ≧3.0 and ≦9.0 at 20° C. The selection of this pH range allows for applying the multi-component system of the invention directly ont human or animal skin.

To further improve the skin compatibility, component B1 can preferably have a pH-value of ≧3.5 and ≦8.0, in particular of ≧4.0 and ≦6.5. In this pH range, even on sensitive skin, virtually no skin irritations occur. At the same time, the multi-component system cures with the above-mentioned high speed after mixing the components A and B.

The aforementioned pH ranges can be adjusted in principle in every possible way. Thus, component B1 can contain at least one acid, one base or one buffer system. Preferably, component B1 contains at least one buffer system. For example, the comparison of two multi-component systems of the invention, wherein one component comprises an acid in the aqueous phase and the other component comprises a buffer system at the same pH-value in the aqueous phase, shows that the multi-component system featuring the buffer system has improved properties, in particular by means of forming fine-pored foams.

Suitable acids are organic and inorganic compounds, which are at least partially water-soluble and thereby shift the pH-value towards or into the acidic area. For example, these are mineral acids such as phosphoric acid. Suitable organic acids that can be used are, for example, formic acid, acetic acid, various α-chloroacetic acids, lactic acid, malic acid, citric acid, tartaric acid, succinic acid and the like. Mixtures of the aforementioned substances may also be used.

Bases that can be used in accordance with the invention can be of organic or inorganic origin and can be at least partially water-soluble and thereby shift the pH-value towards or into the basic range. These are, for example, alkaline metal hydroxides or alkaline earth metal hydroxides such as sodium or potassium hydroxide, ammonia, to name only a few. Possible organic bases are, for example, nitrogen-containing compounds such as primary, secondary, tertiary aliphatic or cycloaliphatic amines as well as aromatic amines. In addition, mixtures of the aforementioned substances can also be utilized.

A buffer system according to the invention typically comprises a mixture of a weak acid and its conjugate base, or vice versa. Ampholytes can also be used. The buffer systems used in the present invention are, in particular, selected from acetate buffer, phosphate buffer, carbonate buffer, citrate buffer, tartrate buffer, succinic acid buffer, TRIS, HEPES, HEPPS, MES, Michaelis buffer or mixtures thereof. However, the present invention is not limited to the aforementioned systems. In principle, any buffer system can be used, which can be adjusted in a way so that the claimed pH region can be controlled.

In a preferred embodiment of the invention, the buffer system is based on organic carboxylic acids and their conjugate bases. More preferably, the organic carboxylic acids possess one, two or three carboxylic acid groups. Most preferably, the buffer system is based on acetic acid, succinic acid, tartaric acid, malic acid or citric acid and the respective conjugate base. In addition, mixtures of the aforementioned substances can also be utilized.

It is preferred that the prepared foams cure particularly quickly. When component B1 is mixed with polyols B2 as claimed in present invention, this addition may slow down the curing reaction. Surprisingly it has been found that the foams cure very quickly, even if the polyols of the invention are added, if buffer systems are used that are based on organic carboxylic acids and their conjugate bases.

In a further embodiment of the multi-component system of the invention, the concentration of the buffer system in B1 is preferably ≧0.001 mol/L and ≦2.0 mol/L, more preferably ≧0.01 mol/L and ≦1, 0 mol/L and most preferably ≧0.01 mol/L and ≦0.5 mol/L.

These concentrations are particularly preferred, since, on the one hand, sufficient buffer capacity is provided and, on the other hand, crystallization of the buffer from the aqueous component does not occur under ordinary storage conditions. For example this would be disadvantageous for the use in pressure cells, since crystallized components may clog the mixer or the nozzle of the pressure cell.

More preferably, the buffer capacity of the component B1 is ≧0.01 mol/L, in particular ≧0.02 and ≦0.5 mol/L.

In accordance with the invention, component B comprises a component B2, which contains a polyol having at least two OH-groups and having a molecular weight of ≧62 g/mol and ≦500 g/mol, preferably ≧62 g/mol and ≦400 g/mol and more preferably ≧62 g/mol and ≦300 g/mol. Polyols in accordance with the invention are preferably selected from ethylene glycol, glycerol or sorbitol. In addition, mixtures of the aforementioned substances can also be employed.

In a preferred embodiment of the invention, the polyol of component B2 has at least three OH-groups. It is particularly preferred that the polyol component B2 is selected from glycerol and/or sorbitol, most preferably solely glycerol.

In a further preferred embodiment, the polyols of component B2 are miscible with water.

The content of component B2 in component B is, in accordance with the invention, >20 wt.-% and ≦80 wt.-%, preferably ≧35 wt.-% and ≦75 wt.-% and more preferably ≧40 wt.-% and ≦70 wt.-%.

Component B should be stable when stored for several months in a spray system. When stored or transported at low temperatures, a component B purely based on B1 would be in danger to freeze at temperatures below 0° C. Due to the expansion of the formed ice, the spray system could be irreversibly damaged with the result that its function is impaired and the spray system may not be used reliably. The addition of appropriate quantities of water-mixable polyols leads to a significant reduction of the freezing point.

Within the scope of the present invention, it may also be advantageous to adjust the viscosity of component B, for example to improve the miscibility with a silane-terminated pre-polymer in a mixer of a two-chamber pressure cell. Thus, the dynamic viscosity of the component B at 23° C. can be 10 mPas to 4000 mPas, in particular 300 mPas to 1000 mPas. It is particularly useful to determine the viscosity by rotational viscometry in accordance with DIN 53019 at 23° C. using a rotational viscometer at a rotational frequency of 18 s⁻¹ from Anton Paar Germany GmbH, Ostfildern, DE.

According to a particularly preferred embodiment of the multi-component system of the invention, the component B can contain a thickener. With the help of the thickener the above mentioned viscosities can be set. A further advantage of the thickener is its, at least to some extent, stabilizing effect on the foam and in this regard the thickener is able to make a contribution to maintaining the foam structure until it reaches self-supporting capacity.

Moreover, it was surprisingly found that by the addition of thickeners, in particular thickeners based on starch or cellulose, a number of commercially available propellants do dissolve in component B. As the solubility of these propellant gases in component A is rather less problematic, a phase separation of propellant gas and components A and B in the respective chambers of the multi-chamber pressure cell is thereby prevented. In this regard, the propellant gas and component A or the propellant gas and component B remain as a substantially homogeneous mixture until leaving the pressure cell. After the two components A and B, which are stored separately in the pressure cell, are mixed in a mixing nozzle of the pressure cell, the propellant gas, dissolved in the mixture, causes a rapid expansion of this mixture after leaving the pressure cell, with the result that a foam with fine pores is obtained. Consequently, thickeners that are particularly advantageous for this use are selected from starch, starch derivatives, dextrin, polysaccharide derivatives such as guar gum, cellulose, cellulose derivatives, in particular cellulose ethers, cellulose esters, fully synthetic organic thickeners based on polyacrylic acid, polyvinylpyrrolidones, poly(methyl)acrylic compounds or polyurethanes (associative thickeners) and also inorganic thickeners, such as bentonites or silicas or mixtures thereof. Specific examples include methyl cellulose or carboxymethyl cellulose, for example in form of sodium salt.

In the context of the present invention, it is further envisioned that component B comprises a polyurethane dispersion. It is to be understood, in the context of the present invention, that it is possible to use, for example, a commercial polyurethane dispersion, whose concentration can be lowered by means of adding water, and which can be adjusted to reach the above-mentioned pH range, using the above-mentioned options.

Another advantage of the aforementioned pH-values is, in combination with the provision of a polyurethane dispersion, that, in this range, usually no coagulation of the polymer particles of the polyurethane dispersion takes place. In other words, under these conditions the dispersion is storage-stable. Surprisingly it has been found that the solubility of commercially available propellants in the aqueous component can be further increased by the use of a polyurethane dispersion. Therefore, the utilization of a polyurethane dispersion and of a thickener of the above mentioned type is particularly preferred.

In principle, all commercially available polyurethane dispersions can be used as the polyurethane dispersion. However, also in this case it is advantageous to use polyurethane dispersions, which have been prepared from isocyanates devoid of aromatic compounds, as these are safer, in particular, for medical applications. In addition, the polyurethane dispersion can include further ingredients. In a preferred embodiment, the polyurethane dispersion contains 5 wt.-% to 65 wt.-% polyurethane, in particular 20 wt.-% to 60 wt.-%.

In further developing of the multi-component system of the invention, the weight average of polyurethane in the polyurethane dispersion is 10,000 g/mol to 1,000,000 g/mol, in particular 20,000 g/mol to 200,000 g/mol, respectively determined by gel permeation chromatography using a polystyrene standard in tetrahydrofurane at 23° C. Polyurethane dispersions of these molecular weights are particularly advantageous, as they constitute storage-stable polyurethane dispersions; in addition, they provide good solubility of the propellant gas in component B during the process of filling into pressure cells.

In a preferred embodiment of the invention, component A comprises an alkoxysilane-terminated polyurethane pre-polymer, which is obtained by reacting an alkoxysilane, comprising at least one isocyanate-reactive group, with an isocyanate-terminated pre-polymer.

In accordance with the present invention, the silane-terminated pre-polymer contained in component A may, in principle, comprise all types of polymer backbones, as well as mixtures thereof. According to a preferred embodiment, the alkoxysilane-terminated pre-polymer comprises an alkoxysilane-terminated polyurethane pre-polymer. The same is preferably obtained by reacting an alkoxysilane having at least one isocyanate-reactive group, with an isocyanate-terminated pre-polymer. Alternatively, however less preferably, it is also possible to react an OH-functional pre-polymer with an isocyanate-functional alkoxysilane. However, in this case, the silane-terminated pre-polymers so obtained have a higher viscosity compared to the silane-terminated pre-polymers obtained from the reaction of isocyanate-functional pre-polymer and isocyanate-reactive alkoxysilanes, and hence are less suitable for spray foam applications.

In this regard, the polyurethane pre-polymer can be built-up in different ways. Thereby, one possibility is to produce a polymer backbone by reacting diisocyanates with polyols, resulting in a polymer backbone having a multitude internal urethane groups. Thereby, silane-terminated pre-polymers are obtained, which, depending on the chain length, allow for the production of relatively solid foams. The respective polyols are preferably selected from polyether polyols, polyester polyols and polycarbonate polyols; however, mixtures of said polyols can also be utilized. Particularly preferred polyols are polyether polyols.

The polyols as used preferably have an average molecular weight Mₙ of 500 g/mol to 6,000 g/mol, more preferably 1000 g/mol to 5000 g/mol, most preferably 1000 g/mol to 3000 g/mol. The polyol as used preferably has an OH-functionality of 2 to 4, more preferably of 2 to 3.5, most preferably from 2 to 3.

A polyurethane pre-polymer in accordance with present invention is also to be understood as a polymer backbone that, for example, has only polyether groups, polycarbonate groups and/or polyester groups in its main chain, and that has isocyanate groups at its chain ends. Such a polymer backbone is particularly advantageous for medical applications, because the corresponding silane-terminated pre-polymer has a sufficiently low viscosity with the result that it can be easily foamed. In contrast, urethane or urea groups are less preferred in the polymer backbone, since they can increase the viscosity considerably.

Suitable hydroxyl-containing polyesters are, for example, transformation products of polyvalent, preferably bivalent alcohols with polyvalent, preferably bivalent polycarboxylic acids. Instead of free carboxylic acids, the corresponding polycarboxylic anhydrides or corresponding polycarboxylic acid esters of lower alcohols, or mixtures thereof, can also be used for producing the polyesters. The polyester polyols may be mono-functional or multi-functional, in particular they are difunctional.

The polycarboxylic acids may be of aliphatic, cycloaliphatic, aromatic and/or heterocyclic nature and may, when appropriate, for example, be substituted by halogen atoms and/or be unsaturated. Preferred are aliphatic and cycloaliphatic dicarboxylic acids. Examples of these are:

Succinic acid, adipic acid, azelaic acid, sebacic acid, phthalic acid, tetrachlorophthalic acid, isophthalic acid, terephthalic acid, tetrahydrophthalic acid, hexahydrophthalic acid, cyclohexane dicarboxylic acid, itaconic acid, sebacic acid, glutaric acid, suberic acid, 2-methyl succinic acid, 3,3-diethyl glutaric acid, 2,2-dimethyl succinic acid, maleic acid, malonic acid, fumaric acid or dimethyl terephthalate. Anhydrides of these acids may also be used, if they exist. Examples of these are maleic anhydride, phthalic anhydride, tetrahydrophthalic anhydride, glutaric anhydride, hexahydrophthalic anhydride and tetrachlorophthalic anhydride.

A polycarboxylic acid optionally to be used concomitantly in small quantities is trimellitic acid.

Suitable polyvalent alcohols that are preferably used are diols. Examples of such diols are e.g. ethylene glycol, propylene glycol-1,2, propylene glycol-1,3, butanediol-1,4, butanediol-2,3, diethylene glycol, triethylene glycol, hexanediol-1,6, octanediol-1,8, neopentyl glycol, 2-methyl-1,3-propanediol or hydroxypivalic acid neopentylglycolester. Polyesters of lactones may also be used, e.g. ε-caprolactone. Polyols that can be optionally used are, e.g. trimethylolpropane, glycerol, erythritol, pentaerythritol, trimethylolbenzene, trishydroxyethyl isocyanurate.

Suitable hydroxyl group-containing polyethers are those, which are produced by polymerization of cyclic ethers, such as ethylene oxide, propylene oxide, butylene oxide, tetrahydrofuran, styrene oxide or epichlorohydrin, with themselves, e.g. in the presence of BF₃, or basic catalysts, or by addition of these cyclic compounds, optionally as a mixture or successively, to starting components having reactive hydrogen atoms, such as alcohols and amines or amino alcohols, e.g. water, ethylene glycol, glycerol, trimethylolpropane, pentaerythritol, sorbitol, ethylene diamine, propylene glycol-1,2 or propylene glycol-1,3.

Preferred hydroxyl group-containing polyethers are those, which are based on ethylene oxide, propylene oxide or tetrahydrofuran or mixtures of these cyclic ethers.

An advantage of the polyether units or the polyester units and/or polycarbonate units in the polymer backbone is that the hydrophilicity of the resulting foam can be adjusted as desired according to intended use, with the result that the foam shows, for example, a better absorption of aqueous fluids such as blood or wound secretion. The hydrophilicity can be adjusted, e.g. through the amount of ethylene oxide groups in the polyether polyols. However, it is advisable to set the amount of ethylene oxide units in the polyether not too high, as this would otherwise lead to a swelling of the wound dressing. In this regard, a preferred embodiment of the composition in accordance with the invention is defined by the amount of the ethylene oxide units in the polyether polyol being ≦50 wt.-%, preferably ≦30 wt.-%, more preferably ≦20 wt.-%. The lower limit of ethylene oxide groups can be, for example ≧5 wt.-%. However, polyether polyols can also be used without ethylene oxide units.

Polycarbonate polyols according to the invention that can be used, are in particular, the generally known reaction products of bivalent or multivalent alcohols with diaryl carbonates, e.g. diphenyl carbonate, dimethyl carbonate or phosgene. Suitable polycarbonate polyols may also contain additional ester groups in addition to carbonate structures. These are, in particular, the generally known polyester carbonate diols, which can be obtained for example, in accordance to the teaching of DE-AS 1 770 245 by reaction of bivalent or multivalent alcohols with lactones, such as in particular ε-caprolactone, and subsequent reaction of the resulting polyester diols with diphenyl carbonate or dimethyl carbonate. Also suitable are polyether carbonate polyols, which contain additional ether groups in addition to carbonate structures. These are, in particular, the generally known polyether carbonate polyols, which can be obtained for example, according to the method of EP-A 2046861 by catalytic transformation of alkylene oxides (epoxides) and carbon dioxide, in the presence of H-functional starting materials.

The polyether polyols, or polyether polyols and/or polycarbonates that can be used in accordance with the present invention, may be composed of aliphatic units, or may possess aromatic groups.

Suitable for the preparation of the alkoxysilane-terminated pre-polymer of the invention are, in general, aromatic, araliphatic, aliphatic or cycloaliphatic polyisocyanates having an NCO-functionality of ≧2, which are in principle known to the skilled person. Examples of such polyisocyanates are 1,4-butylene diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof of any isomer ratio, 1,4-cyclohexylene diisocyanate, 1,4-phenylene diisocyanate, 2,4- and/or 2,6-toluene diisocyanate, 1,5-naphthylene diisocyanate, 2,2′- and/or 2,4′- and/or 4,4′-diphenylmethane diisocyanate, 1,3- and/or 1,4-bis(2-isocyanato-prop-2-yl)-benzene (TMXDI), 1,3-bis(isocyanatomethyl)benzene (XDI), alkyl-2,6-diisocyanatohexanoate (lysine diisocyanate) with C1-C8 alkyl groups, as well as 4-isocyanatomethyl-1,8-octane diisocyanate (nonantriiso diisocyanate), and triphenylmethane-4,4′,4″-triisocyanate.

Modified diisocyanates or triisocyanates with an uretdione structure, isocyanurate structure, urethane structure, allophanate structure, biuret structure, iminooxadiazindione structure and/or oxadiazintrione structure, can also be used, in suitable proportions, in addition to the aforementioned polyisocyanates.

Preferred are polyisocyanates or polyisocyanate mixtures of the aforementioned kind with exclusively aliphatic and/or cycloaliphatic bound isocyanate groups. Particularly preferably, these have an average NCO-functionality from 2 to 4, preferably 2 to 2.6, and particularly preferably of 2.

This is advantageous as aromatic isocyanates pose a greater health hazard. Therefore, in particular for medical applications of the aforementioned type, such compounds should be avoided.

Alkoxysilanes possessing at least one isocyanate group and/or an isocyanate-reactive group are suitable for being the terminating moiety of the above-mentioned isocyanate pre-polymers or OH-functional pre-polymers. Isocyanate-reactive groups are functional groups that can react with isocyanate groups by cleavage of hydrogen. Isocyanate reactive groups are preferably OH-groups, SH-groups and/or amino groups.

Isocyanate-functional pre-polymers are preferably terminated with an amount of isocyanate-reactive group-containing alkoxysilanes, so that no free isocyanate groups can be detected through titration or IR spectroscopy, in accordance with the methods described in the methods section. Thus, the alkoxysilane-terminated pre-polymer can be described as being isocyanate-free.

Suitable isocyanate group-containing alkoxysilanes are well known to the skilled person, for example aminopropyltrimethoxysilane, mercaptopropyltrimethoxysilane, aminopropylmethyl-dimethoxysilane, mercaptopropylmethyldimethoxysilane, amino-propyltriethoxysilane, mercaptopropyltriethoxysilane, aminopropylmethyldiethoxy-silane, mercaptopropylmethyl-diethoxysilane, aminomethyltrimethoxysilane, amino-methyltriethoxysilane, (aminomethyl)-methyldimethoxysilane, (aminomethyl)methyldiethoxysilane, N-butylaminopropyl-trimethoxysilane, N-ethylaminopropyltrimethoxy-silane, N-phenyl-aminopropyl-trimethoxysilane, N-(3-triethoxysilylpropyl)aspartic acid diethylester, N-(3-trimethoxysilylpropyl)aspartic acid diethylester, N-(3-dimethoxymethylsilylpropyl)aspartic acid diethylester, (N-cyclohexylaminomethyl)methyldiethoxysilane, (N-cyclohexylaminomethyl)-triethoxysilane, (N-phenylamino-methyl)methyldimethoxysilane and/or (N-phenylamino-methyl)trimethoxysilane, well suited are (N-cyclohexylaminomethyl)methyldiethoxysilane, (N-cyclohexylamino-methyl)triethoxysilane, (N-phenylaminomethyl)methyldimethoxysilane and/or (N-phenylaminomethyl)trimethoxysilane, and particularly well suited is (N-cyclo-hexylamino-methyl)methyldiethoxysilane and/or (N-cyclohexylaminomethyl)triethoxysilane.

Suitable isocyanate group possessing alkoxysilanes are also known, in principle. Examples are isocyanatomethyltrimethoxysilane, isocyanatomethyltriethoxysilane, (isocyanatomethyl)-methyldimethoxysilane, (isocyanatomethyl)methyldiethoxysilane, 3-isocyanatopropyl-trimethoxysilane, 3-isocyanatopropylmethyldimethoxysilane, 3-isocyanatopropyltriethoxy-silane and 3-isocyanatopropylmethyldiethoxysilane. The use of 3-isocyanatopropyl-trimethoxysilane and 3-isocyanatopropyltriethoxysilane is preferred.

The use of di- or trialkoxysilanes is preferred, the use of trialkoxysilanes is particularly preferred, and the use of of triethoxysilanes and/or trimethoxysilanes is most preferred.

In a preferred embodiment of the multi-component system of the invention, the alkoxysilane-terminated pre-polymer possesses α-silane groups. In this regard, the alkoxysilane-terminated pre-polymer as included therein exclusively has α-silane groups. An α-silane group possesses an methyl spacer between the silicon atom and the backbone polymer or the backbone polymer's first electron donating atom (such as an N or an O atom). Such silanes are characterized by a particular reactivity with regard to the condensation reaction. In the context of the present invention, it is therefore possible to completely avoid the use of heavy metal-based crosslinking catalysts such as organic titanates or organotin(IV) compounds. This is particularly advantageous for the application of the composition of the invention in medical areas.

It is also preferable, if the α-silane groups of the used alkoxysilane-terminated pre-polymer are dialkoxy- or trialkoxy-α-silane groups, more preferably are diethoxy-, dimethoxy-, triethoxy- or trimethoxy-α-silane groups.

More preferably, the number average molecular weight Mₙ of the alkoxysilane-terminated pre-polymer is 500 g/mol to 20,000 g/mol, preferably 500 g/mol to 6000 g/mol, particularly preferably 2000 g/mol to 5000 g/mol. The aforementioned molecular weights are particularly advantageous in regard to polyether polyols and polyester polyols, since the cured compositions of the invention that can be prepared therefrom may then optionally be adjusted from very soft to very firm.

The number average molecular weight Mₙ of all the polyols and pre-polymers is determined as described in the methods section.

In a preferred embodiment of the invention, component A contains additional alkoxysilane-terminated pre-polymers and/or alkoxysilane-terminated polyisocyanates. The preferred embodiments outlined above in this regard apply also to the other alkoxysilane-terminated prepolymers. The alkoxysilane-terminated polyisocyanates can be obtained by reacting diisocyanates, modified diisocyanates or triisocyanates of uretdione structure, isocyanurate structure, urethane structure, allophanate structure, biuret structure, iminooxadiazinedione structure and/or oxadiazinetrione structure, or of mixtures of the aforementioned compounds with alkoxysilanes, having at least one isocyanate-reactive group. Preferably used are polyisocyanates having isocyanurate structures (for example Desmodur N 3300 from Bayer Material Science AG), iminooxadiazindione structures (for example Desmodur N 3900 from Bayer Material Science AG) and/or allophanate structures (for example Desmodur XP 2580 from Bayer Material Science AG). The compounds already mentioned above are also suitable as alkoxysilanes, having at least one isocyanate-reactive group. The proportion of the other alkoxysilane-terminated pre-polymers and/or alkoxysilane-terminated polyisocyanates in component A is preferably ≧0 wt.-% and ≦60 wt.-%, more preferably ≧1 wt.-% and ≦30 wt.-%, and most preferably ≧5 wt.-% and ≦15 wt.-%.

The component A of the multi-component system of the invention, and thus the entire multi-component system of the invention as well, is preferably free of monomeric isocyanate compounds; this means a system containing less than 0.5 wt.-% of the monomeric isocyanate compounds. This can be accomplished by various means known to the skilled person. Particularly suitable according to the invention is a purification of the pre-polymers by distillation, in particular by thin-layer distillation. This purification process is particularly advantageous because it has been found that compositions whose pre-polymers were deprived of polyisocyanates via a thin-layer distillation, could be better foamed, as the viscosity of the compositions can be adjusted more easily and overall less viscous pre-polymers are obtained. The thin-layer distillation may be performed, for example, after the preparation of the isocyanate-terminated pre-polymers, i.e. before the termination of this intermediate with alkoxysilanes.

In a further preferred embodiment of the multi-component system of the invention, component A and/or B contain(s) a medical or cosmetic active ingredient.

In this multi-component system, it is also imaginable to provide the active ingredient(s) as an additional component, i.e. as a third or fourth component, and to mix it with components A and B only immediately before application of the multi-component system. Due to the increase in complexity of the multi-component system with an increasing number of separate components, this approach is usually only useful, if the active ingredients are incompatible with both the component A, and with the component B.

The active ingredients may be provided as the active compound as such or in encapsulated form, for example, to achieve a delayed release.

Cosmetic active ingredients to be considered are in particular those substances that possess skin care properties, such as moisturizing or skin-soothing ingredients.

Medical agents that can be used in accordance to the present invention are a variety of drug types and classes.

Such a medicinal agent could comprise for example, a component that releases nitrogen monoxide under in vivo conditions, preferably L-arginine or a L-arginine-containing component or a L-arginine-releasing component, particularly preferably L-arginine hydrochloride. Proline, ornithine and/or other biogenic intermediates such as biogenic polyamines (spermine, spermidine, putrescine or bioactive artificial polyamines) can also be used. Such components are known to support wound healing, wherein their continuous, quantitatively nearly consistent release properties are particularly beneficial for wound healing.

Further active ingredients that can be used in accordance with the invention comprise at least one substance selected from the group of vitamins or pro-vitamins, carotenoids, analgesics, antiseptics, hemostatic, antihistamines, antimicrobial metals or salts thereof, herbal wound healing-supporting substances or mixtures of substances, plant extracts, enzymes, growth factors, enzyme inhibitors and combinations thereof.

Suitable analgesics are, in particular, non-steroidal analgesics in particular salicylic acid, acetylsalicylic acid and derivatives thereof such as Aspirin®, aniline and derivatives thereof, acetaminophen, such as Paracetamol®, anthranilic acid and derivatives thereof, such as mefenamic acid, pyrazole or derivatives thereof, such as methimazole, Novalgin®, phenazone, Antipyrin®, isopropylphenazone and most preferably arylacetic acids and derivatives thereof, heteroarylacetic acids and derivatives thereof, arylpropionic acids and derivatives thereof, and heteroarylpropionic acids and derivatives thereof, such as Indometacin®, Diclophenac®, Ibuprofen®, Naxoprophen®, Indomethacin®, Ketoprofen®, Piroxicam®.

Growth factors that have to be mentioned are, in particular: aFGF (acidic Fibroblast Growth Factor), EGF (Epidermal Growth Factor), PDGF (Platelet Derived Growth Factor), rhPDGF-BB (becaplermin), PDECGF (Platelet Derived Endothelial Cell Growth Factor), bFGF (basic Fibroblast Growth Factor), TGF a; (Transforming Growth Factor alpha), TGF β (Transforming Growth Factor beta), KGF (Keratinocyte Growth Factor), IGF1/IGF2 (Insulin-like Growth Factor) and TNF (Tumor Necrosis Factor).

Suitable vitamins or pro-vitamins are particularly fat-soluble or water-soluble vitamins, vitamin A, group of retinoids, pro-vitamin A, group of carotenoids, in particular β-carotene, vitamin E, group of tocopherols, in particular α-tocopherol, β-tocopherol, γ-tocopherol, δ-tocopherol and α-tocotrienol, β-tocotrienol, γ-tocotrienol and δ-tocotrienol, vitamin K, phylloquinone in particular phytomenadione or herbal vitamin K, vitamin C, L-ascorbic acid, vitamin B1, thiamine, vitamin B2, riboflavin, vitamin G, vitamin B3, niacin, nicotinic acid and nicotinic acid amide, vitamin B5, pantothenic acid, pro-vitamin B5, panthenol or dexpanthenol, vitamin B6, vitamin B7, vitamin H, biotin, vitamin B9, folic acid and combinations thereof.

Agents to be used as antiseptics are those that are or that have an effect, which is germicidal, bactericidal, bacteriostatic, fungicidal, virucidal, virustatic and/or generally is effective microbiocidally.

Substances that are particularly suitable are those, which are selected from the group resorcinol, iodine, povidone iodine, chlorhexidine, benzalkonium chloride, benzoic acid, benzoyl peroxide or cetylpyridinium chloride. In addition, antimicrobial metals in particular are also to be used as antiseptics. In particular silver, copper or zinc and salts thereof, oxides or complexes in combination or separately may be used as anti-microbial metals.

Herbal, wound-healing supporting agents that may be mentioned in the context of current invention are, in particular, extracts of chamomile, hazel (hamamelis) extracts such as hamamelis virginiana, calendula extract, aloe extract such as aloe vera, aloe barbadensis, aloe ferox or aloe vulgaris or, green tea extract, seaweed extract such as red algae extract or green algae extract, avocado extract, myrrh extract such as commophora molmol, bamboo extracts and combinations thereof.

The amount of active ingredients depends predominantly on the dose necessary for medical reasons as well as the compatibility with the other components of the composition of the invention.

Furthermore, additional auxiliary substances may also be added to the multi-component system of the invention. Possible are, for example, foam stabilizers, thixotropic agents, antioxidants, light stabilizers, emulsifiers, plasticizers, pigments, fillers, additives for package stabilization, biocides, cosolvents, and/or flow control agents.

Suitable foam stabilizers are, for example, alkylpolyglycosides. These can be obtained via methods that are, in principle, known to the skilled person, i.e. the reaction of long-chained monoalcohols with mono-, di- or polysaccharides (Kirk-Othmer Encyclopedia of Chemical Technology, John Wiley & Sons, Vol. 24, p. 29). The long-chained monoalcohols, which may optionally also be branched, preferably have 4 to 22 C-atoms, preferably 8 to 18 C-atoms and particularly preferably 10 to 12 C-atoms in one alkyl group. Relatively long-chained monoalcohols that should be specifically mentioned are 1-butanol, 1-propanol, 1-hexanol, 1-octanol, 2-ethylhexanol, 1-decanol, 1-undecanol, 1-dodecanol (lauryl alcohol), 1-tetradecanol (myristyl alcohol) and 1-octadecanol (stearyl alcohol). Mixtures of the long-chained monoalcohols a be used.

Preferably, these alkylpolyglycosides possess glucose-derived structures. Alkylpolyglycosides of formula (I) are particularly preferably used:

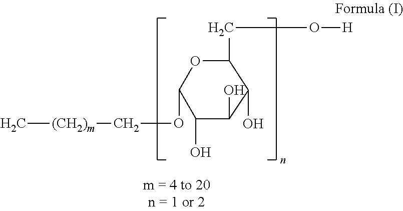

Preferably, m is a number from 6 to 20, particularly preferably from 10 to 16.

The alkylpolyglycosides preferably have an HLB value of less than 20, more preferably of less than 16 and particularly preferably of less than 14, wherein the HLB value is calculated according to the formula HLB=20·Mh/M, with Mh the molecular weight of the hydrophilic fraction of a molecule and M the molecular weight of the entire molecule (Griffin, W. C.: Classification of surface active agents by HLB, J. Soc. Cosmet. Chem. 1, 1949).

Other foam stabilizers comprise anionic, cationic, amphoteric and nonionic surfactants and mixtures thereof as known form the art, in principle. Preferably used are alkylpolyglycosides, EO/PO block copolymers, alkyl-alkoxylates or aryl-alkoxylates, siloxane alkoxylates, esters of sulfonic succinic acid and/or alkaline metal alkanoates or alkaline earth metal alkanoates. Particularly preferred are EO/PO block copolymers.

These foam stabilizers may be added to component A and/or preferably to component B, provided that no chemical reaction occurs with the respective components. In this respect, the total content of these compounds with regard to the multi-component system of the invention is, in particular, 0.1 wt.-% to 20 wt.-%, preferably 1 wt.-% to 10 wt.-%.

In addition, to improve the foam properties of the resulting foam, 1 wt.-% to 20 wt.-%, preferably 1 wt.-% to 10 wt.-% of monovalent alcohols, and mixtures thereof may be used. These are monovalent alcohols such as ethanol, propanol, butanol, decanol, tridecanol, hexadecanol and monofunctional polyether alcohols and polyester alcohols.

It is advantageous to adjust the ratio of components A and B of the multi-component system of the invention, to each other, in a way that a complete polymerization occurs, while component A is ideally quantitatively transformed. For example, components A and B of the multi-component system of the invention are therefore provided at a volume ratio of 1:10 to 10:1 to each other, preferably at a volume ratio of 1:1 to 5:1 to each other, in particular 2:1 to 3:1, most preferably at about 2.5:1.

Further subject-matter of the present invention is a shaped object, obtainable by polymerization of a multi-component system of the invention.

This shaped object can be obtained by mixing components A and B of a multi-component system of the invention and completing polymerization of the mixtures formed thereby. The shaped object of the invention may be foamed or non-foamed. However, it is preferred that the same is a foamed shaped object.

The mixture polymerizes completely, preferably at room temperature, over a period of a maximum of ten minutes, more preferably within four minutes, and particularly preferably within a maximum of two minutes.

Complete polymerization in accordance with the present invention is to be understood as that not only an external skin formation takes place, in other words, that the outer shell of the shaped object is no longer sticky, but that the pre-polymers are substantially completely transformed. This is verified in the context of the present invention by means of completely pressing in the shaped object with a finger for a few seconds and subsequently, when removing the pressure of the finger, the shaped object returns by itself into the starting position.

Fast curing is particularly advantageous in medical applications, especially when using the multi-component system of the invention as a sprayable foaming wound dressing. Only because of the extremely rapid curing of the composition of the invention, the wound dressing can be bandaged sufficiently fast and be exposed to mechanical stress by the patient. This way, long delays may be avoided.

Thus, another subject of the invention is a shaped object, which is obtainable by polymerization and foaming of a multi-component system of the invention and is characterized by the shaped object being a wound dressing.

Therefore, after mixing the two components A and B, the multi-component system of the invention can be sprayed, or applied in a different way, onto skin injuries or other of kinds injuries. In this regard, the foamed multi-component system does not stick noticeably to organic tissue, such as wound tissue, and is capable, due to its pore structure, to absorb wound secretion or blood. This is presumaby due to the fact that the multi-component system of the invention when being sprayed under the above mentioned conditions, forms an at least partially open pore structure, and is thus absorbent.

Such a wound dressing according to the invention has the additional advantage that not only wound secretions can be absorbed by the foam structure, but that, simultaneously, mechanical protection of the wound from blows and the like is achieved. The pressure of garments on the wound is also partially absorbed by the foam structure.

Furthermore, the sprayed wound dressing adapts itself perfectly to the mostly irregular contours of a wound, thus ensuring a wound covering largely free of pressure pain caused by inappropriate wound dressings. In addition, the wound dressing produced according to the invention shortens the time required for the wound treatment in comparison to a treatment with a traditional wound dressing, since no adjustment by time-consuming cutting is required.

The present invention further relates to a multi-chamber pressure cell with a discharge valve and a mixing nozzle, containing a multi-component system of the invention, wherein the components A and B of the multi-component system are filled separately in a first and a second chamber of the multi-chamber pressure cell and the first and/or the second chamber each are provided with a propellant gas under elevated pressure, wherein the propellant gas(es) of the first and second chambers may be the same or different.

It is particularly preferred that the first and/or the second chamber have an applied pressure of at least 1.5 bar.

In a further embodiment of the multi-chamber pressure cell according to the invention, the propellant gases are soluble both in component A and in component B, wherein the solubility is at least 3 wt.-% at a filling pressure of at least 1.5 bar and at a temperature of 20° C., and wherein, in particular, there is as much propellant gas filled in as possible in accordance with the respective solubility. Thereby, a consistent quality of the sprayed foam is ensured, since it is not only propellant gas that is escaping from one of the chambers at the beginning of the spraying process resulting in a not optimal mixing ratio of components A and B. For this purpose, mainly multi-component systems are considered that feature one of the above mentioned thickeners and/or a polyurethane dispersion in component B.

A further advantage is based on the fact that no phase separation may occur between component A or B and the propellant gas, because of the solubility of the propellant gas in the chambers of the pressure cell. Therefore, the propellant gas only escapes at the triggering of the pressure cell thus mixing components A and B, and foaming the mixture in the process. The very fast curing of the multi-component system of the invention results in the fact that the foam structure foamed by the propellant gas is “frozen” and does not collapse.

The above-mentioned effect is enhanced by the use of a thickener of the above-mentioned kind and/or of a polyurethane dispersion in component B, since the thickener as well as the dispersion have, to some extent, a stabilizing effect on the foam. A propellant gas solubility of at least 3 wt.-% is advantageous to ensure sufficient foaming of the discharged mixture. Preferably, the component A contains an amount of propellant gas of 10 wt.-% to 40 wt.-%, more preferably of 15 wt.-% to 30 wt.-% and component B a content of propellant gas of 3 wt.-% to 20 wt.-%, particularly preferably of 5 wt.-% to 15 wt.-%, in each case based on the resulting total weight of the respective mixture. In this case, the foam structure, too, may be influenced by the quantity of propellant gas filled in or dissolved in the individual components. Thus, a higher amount of propellant gas in a composition generally results in foam of lower density.

Most preferably, the propellant gas is selected from dimethyl ether, alkanes, such as propane, n-butane, iso-butane, and mixtures thereof. These propellants are particularly advantageous as it has been found that these are highly soluble in component A, which contains the silane-terminated pre-polymer. In terms of solubility in component B, in particular when using the above mentioned thickeners and/or polyurethane dispersion in the aqueous component, the above mentioned propellant gases are sufficiently soluble. Of the above-mentioned propellants, alkanes are most particularly preferred.

Although the provision of a multi-component system of the invention in pressure cells is a convenient possibility, the invention is not limited to such an embodiment. Thus, the multi-component system of the invention may be easily used as a material that can be shaped after mixing.

The present invention is explained in more detail below using examples:

### EXAMPLES

### General

All of the amounts, proportions and percentages as used in the following are, unless stated otherwise, based on the weight and the total amount or on the total weight of the composition.

Unless stated otherwise, all analytical measurements refer to measurements at temperatures of 23° C.

Methods:

The proportion of CO₂ incorporated in the polyether carbonate polyols was determined using ¹H-NMR (Bruker DPX 400, 400 MHz; pulse program zg30, waiting time d1: 5s, 100 scans). Each sample was dissolved in deuterated chloroform. Dimethylterephthalate (2 mg in 2 g CDCl₃) was added to the deuterated solvent as an internal standard. The relevant resonances in the ¹H-NMR (relative to CHCl₃=7.24 ppm) are as follows: carbonate, resulting from carbon dioxide incorporated in the polyether carbonate polyol (resonances at 5.2 to 4.8 ppm), unreacted PO with resonance at 2.4 ppm, polyether polyol (i.e. without incorporated carbon dioxide) with resonances at 1.2 to 1.0 ppm.

The mole fraction of carbonate incorporated in the polymer, the polyether polyol fraction and the unreacted PO are determined by integration of the corresponding signals.

The number average of the molecular weight Mₙ is determined as follows: First, the polyol is treated with acetic anhydride and pyridine. After completion of the reaction, the OH-number is experimentally determined according to DIN 53240-1 by subsequent back-titration of the resulting acetic acid with alcoholic potassium hydroxide standard solution. The OH-number is given in mg KOH per gram of polyol.

The number average molecular weight Mₙ is calculated from the OH-number via the formula number average molecular weight Mₙ=56×1000×OH-functionality/OH-number. Unless expressly stated otherwise, NCO content was determined volumetrically in accordance with DIN-EN ISO 11909.

The test for free NCO groups was carried out using IR spectroscopy (band at 2260 cm⁻¹).

The stated viscosities were determined using rotational viscometry in accordance with DIN 53019 at 23° C. using a rotational viscometer at a rotational frequency of 18 s⁻¹ from Anton Paar Germany GmbH, Ostfildern, DE.

The maximum soluble amount of propellant gas was determined at 20° C. in sight glasses for optical examination of aerosols from the company Pamasol Willi Mader AG, CH. The maximum soluble amount of propellant gas refers to the weight ratio of propellant gas to the substance/mixture to be examined, and was reached when the propellant gas just barely did not form a second phase (>1 h).

For foaming of the mixtures, a 2K-spray apparatus was used and filled in the manner described in PCT applications WO 2012/022686 and WO 2012/022685.

Substances as Used and Abbreviations:
HDI: Hexamethylene-1,6-diisocyanate
Desmodur® N 3300: HDI-trimerisate, NCO content 21.8±0.3 wt.-% (Bayer Material Science AG, Leverkusen, DE)
Geniosil XL 926: [(Cyclohexylamino)methyl]triethoxysilane (Wacker Chemie AG, Munich, DE)
P/B 2.7: Mixture of propane and iso-butane, resulting in a gas pressure of 2.7 bar at 20° C.
Walocel CRT 30G: Carboxymethylcellulose, sodium salt (Dow Deutschland Anlagengesellschaft mbH, Schwalbach, DE)
Tegostab B 8408: Non-hydrolyzable polyetherpolydimethyl siloxane copolymer (Evonik Industries AG, Essen, DE)
Polyether carbonate polyol 1: Polyether carbonate diol based on propylene oxide and CO₂, having an OH-number of 58.2 mg KOH/g (Mₙ=1924 g/mol) and an intrinsic CO₂ content of 15.1 wt.-% and an OH-functionality of 2.

### Example 1

### Preparation of Pre-Polymer P1

650 g HDI was added dropwise at 80° C. for 30 minutes and subsequently stirred for 4 h to a mixture of 1032 g of a polyalkylene oxide having a molecular weight of 4000 g/mol started at 1,2-propylene glycol, with an ethylene oxid weight percentage of 13% and an propylene oxid weight percentage of 86%, which was previously dried at 80° C. for 1 h at a pressure of 0.1 mbar, and 1.8 g of benzoyl chloride.

The excess HDI was removed by thin layer distillation at 130° C. and 0.03 mbar. A pre-polymer having an NCO content of 1.82% was obtained.

### Example 2

### Preparation of Pre-Polymer P2

1044.56 g of hexamethylene diisocyanate (HDI) was added dropwise at 60-65° C. for 15 minutes to a mixture of 800 g of polyether carbonate polyol 1 and 1.89 g dibutylphosphate. Afterwards, the mixture was stirred for 1.5 h at 80° C. The NCO content of this mixture was 25.9%.

The excess HDI was removed by thin layer distillation at 140° C. and 0.15 mbar. A pre-polymer having an NCO content of 3.74% was obtained.

### Example 3

### Preparation of the Alkoxysilane-Terminated Pre-Polymer STP1

24.8 g Geniosil XL 926 was added to 207.5 g of the pre-polymer P1 at 30-40° C. for 15 minutes. After stirring for another 30 min at 30-40° C., complete conversion of the NCO pre-polymer to STP could be shown by IR spectroscopy.

### Example 4

### Preparation of the Alkoxysilane-Terminated Pre-Polymer STP2

84.3 g Geniosil XL 926 was added at 30-40° C. for 15 minutes to 292.7 g of the pre-polymer P1 and 32.5 g of Desmodur N 3300. After stirring for another 30 minutes at 30-40° C., complete conversion of the NCO pre-polymer to STP could be shown by IR spectroscopy.

### Example 5

### Preparation of the Alkoxysilane-Terminated Pre-Polymer STP3

51.2 g Geniosil XL 926 was added to 170.0 g of the pre-polymer P1 and 18.9 g of Desmodur N 3900 at 30-40° C. for 15 minutes. The reaction temperature reached a maximum of 45° C. Afterwards, the mixture was stirred for 1 h at 40-45° C. As a small peak of free NCO could still be detected in IR, further 0.5 g Geniosil XL 926 were added. After stirring for another hour at 35-40° C., complete conversion of the NCO pre-polymer to STP could be shown by IR spectroscopy.

### Example 6

### Preparation of the Alkoxysilane-Terminated Pre-Polymer STP4

36.41 g of Geniosil XL 926 was added to 150 g of the pre-polymer P2 at 30° C. for 15 minutes. The reaction was slightly exothermic; the temperature reached a maximum of 47° C. After stirring for further 2 hours at 30-40° C., complete conversion to the silane-terminated pre-polymer (STP) could be shown by IR spectroscopy.

### Example 7

### Use of STP4

12.1 g STP4 were dissolved in 3.2 g P/B 2.7. As a second component, a mixture of a succinic acid buffer and glycerol was prepared. To achieve this, 23.62 g of succinic acid were mixed with water to result in 1000 mL. 25 mL of this solution were mixed with 25 mL of 0.1 M sodium hydroxide solution and mixed with water to result in 100 mL, and was adjusted with Walocel CRT 30G to reach a viscosity of approximately 500 mPas. The pH-value of this buffer solution was 4.0, the buffer concentration of this solution was 0.05 mol/L. 60 mL of this buffer solution were mixed with 40 mL glycerol.

The two components were separately filled in a one chamber each of a 2 K-spray apparatus that is powered by compressed air, wherein the chambers of the spray apparatus have a volume ratio of 2.5 (STP) to 1 (buffer solution) to each other. A synchronous application of both components at this volume ratio is ensured by design and was carried out by using a static mixer in which the contents were thoroughly mixed. After 40 seconds, a fully cured foam was obtained.

### Example 8

### Use of STP2

11.8 g STP2 were dissolved in 3.2 g P/B 2.7. As a second component a mixture of a citric acid buffer and glycerol was used, which was prepared as follows. 4.202 g of citric acid monohydrate were dissolved in 40 mL of 1 M NaOH and then mixed with water to give 100 mL. 44 mL of 0.1 M hydrochloric acid were mixed with the citric acid solution prepared above to give 100 mL. The pH-value of the solution was 4.5 and was adjusted with 1 N hydrochloric acid to a pH of 4.0, then was adjusted with Walocel CRT 30G to reach a viscosity of approximately 500 mPas; the buffer concentration of this solution was 0.1 mol/L. 35 g of this buffer solution were mixed with 65 g of glycerol and used as a reagent.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 2.5 minutes.

### Example 9

### Use of STP1

12.1 g STP1 were dissolved in 3.4 g P/B 2.7. As a second reagent, a mixture of a citric acid buffer and glycerol was used, which was prepared as follows. 21.008 g citric acid monohydrate were dissolved in 200 mL of 1 M NaOH and then mixed with water to give 1000 mL. 23.1 mL of 0.1 M hydrochloric acid were mixed with the citric acid solution prepared above to give 100 mL and were adjusted with Walocel CRT 30G to reach a viscosity of approximately 500 mPas. The pH-value of this buffer solution is 4.6, the buffer concentration of this solution is 0.077 mol/L. 60 g of this buffer solution were mixed with 40 g glycerol and used as a reagent.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 2 minutes.

### Example 10

### Use of STP2

11.9 g STP2 were dissolved in 3.3 g P/B 2.7. As a second reagent, a mixture of a succinic acid buffer and glycerol was prepared. For this purpose, 23.62 g of succinic acid were mixed with water to give 1000 mL. 25 mL of this solution were mixed with 20 mL of 0.1 M sodium hydroxide solution and mixed with water to give 100 mL, and were adjusted with Walocel CRT 30G to reach a viscosity of approximately 500 mPas. The pH-value of this buffer solution was 4.0, the buffer concentration of this solution was 0.05 mol/L. 60 g of this buffer solution were mixed with 40 g of glycerol.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 1 minute.

### Example 11

### Use of STP3

12.2 g of STP3 were dissolved in 3.3 g P/B 2.7. As a second reagent, a mixture of a succinic acid buffer and glycerol was prepared. For this purpose, 23.62 g of succinic acid were mixed with water to give 1000 mL. 25 mL of this solution were mixed with 20 mL of 0.1 M sodium hydroxide solution and mixed with water to give 100 mL, and were adjusted with Walocel CRT 30G to reach a viscosity of approximately 500 mPas. The pH-value of this buffer solution was 4.0, the buffer concentration of this solution was 0.05 mol/L. 60 g of this buffer solution were mixed with 40 g of glycerol.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 30 seconds.

### Example 12

### Use of STP3

12.2 g STP3 were dissolved in 3.3 g P/B 2.7. As a second reagent a mixture of a succinic acid buffer and glycerol was prepared. For this purpose, 23.62 g of succinic acid were mixed with water to give 1000 mL. 25 mL of this solution were mixed with 50.4 mL of 0.1 M sodium hydroxide solution and mixed with water to give 100 mL, and were adjusted with Walocel CRT 30G to reach a viscosity of approximately 500 mPas. The pH-value of this buffer solution was 4.9, the buffer concentration of this solution was 0.05 mol/L. 60 g of this buffer solution were mixed with 40 g of glycerol.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 2.5 minutes.

### Example 13

### Use of STP2

12.4 g of STP2 were dissolved in 3.1 g P/B 2.7. As a second reagent a mixture of a succinic acid buffer and glycerol was prepared. For this purpose, 23.62 g of succinic acid were mixed with water to give 1000 mL. 50 mL of this solution were mixed with 40 mL of 0.1 M sodium hydroxide solution and mixed with water to give 100 mL, and were adjusted with Walocel CRT 30G to reach a viscosity of approximately 500 mPas. The pH-value of this buffer solution was 4.0, the buffer concentration of this solution was 0.10 mol/L. 35 g of this buffer solution were mixed with 65 g of glycerol.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 30 seconds.

### Example 14

### Use of STP2

11.6 g STP2 were dissolved in 3.3 g P/B 2.7. As a second reagent, a mixture of a acetic acid buffer and glycerol was prepared. For this purpose, 41 mL acetic acid were mixed 9 mL of a 0.2 M sodium acetate solution and mixed with water to give 100 mL. The pH-value of this buffer solution was 4.0, the buffer concentration of this solution was 0.059 mol/L. This buffer was adjusted with Walocel CRT 30G to reach a viscosity of approximately 500 mPas. 60 g of this buffer solution were mixed with 40 g of glycerol.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 2 minutes.

### Example 15

### Use of STP1

12.3 g STP1 were dissolved in 3.1 g P/B 2.7. As a second reagent, a mixture of a succinic acid buffer and sorbitol was prepared. For this purpose, 23.62 g of succinic acid were mixed with water to give 1000 mL. 50 mL of this solution were mixed with 40 mL of 0.1 M sodium hydroxide solution and mixed with water to give 100 mL, and were adjusted with Walocel CRT 30G to reach a viscosity of approximately 500 mPas. The pH-value of this buffer solution was 4.0, the buffer concentration of this solution was 0.1 mol/L. 60 g of sorbitol were added to 40 g of this aqueous buffer solution.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 20 seconds.

### Example 16

### Use of STP2

12.1 g STP2 were dissolved in 3.4 g P/B 2.7. As a second reagent, a mixture of a phosphate buffer and glycerol was used. For this purpose, 9.078 g KH₂PO₄ were dissolved in 1 L of water, as a second solution 11.876 g Na₂HPO₄ were dissolved in 1 L of water. 0.6 mL of the Na₂HPO₄-solution were mixed with the KH₂PO₄-solution to give 100 mL. The pH-value of this buffer solution was 4.9, the buffer concentration of this solution was 0.066 mol/L. This buffer solution was adjusted with Walocel CRT 30G to reach a viscosity of approximately 500 mPas. 60 g of this solution were mixed with 40 g of glycerol.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 9.5 minutes.

### Example 17

### Use of STP1

12.4 g STP1 were dissolved in 3.1 g P/B 2.7. As a second reagent, a mixture of a phosphate buffer and sorbitol was used. For this purpose, 9.078 g KH₂PO₄ were dissolved in 1 L of water, as a second solution 11.876 g Na₂HPO₄ were dissolved in 1 L of water. 15 mL of the Na₂HPO₄-solution were mixed with the KH₂PO₄-solution to give 100 mL. The pH-value of this phosphate buffer was 6.1, the buffer concentration of this solution was 0.07 mol/L. This buffer solution was adjusted with Walocel CRT 30G to reach a viscosity of approximately 500 mPas. 50 g of this solution were mixed with 50 g of sorbitol.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 5 minutes.

### Example 18

### Use of STP1

a) Usage with Glycerol in Accordance with the Invention

12.1 g of STP1 were dissolved in 3.4 g P/B 2.7. As a second reagent a phosphate buffer was used. For this purpose, 1.816 g KH₂PO₄ were dissolved in 100 mL of water, as a second solution 2.375 g Na₂HPO₄ were dissolved in 100 mL of water. 0.6 mL of the Na₂HPO₄-solution were mixed with the KH₂PO₄-solution to give 100 mL. The pH-value of this phosphate buffer was 4.9, the buffer concentration of this solution was 0.13 mol/L. 100 g of this buffer solution was adjusted with 6.6 g Walocel CRT 30G to reach a viscosity of approximately 500 mPas. 60 g of this solution were mixed with 40 g of glycerol.

The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 8.5 minutes.

The cured foam was hydrophilic, after drying at RT overnight. One drop of water was absorbed completely by the foam within 60 seconds. Afterwards this foam was washed for 5 minutes with running warm water (approximately 40° C.) and 10 minutes with running cold water (approximately 15 min). After drying, the drops-test with water showed that the foam again needed approximately 60 seconds to completely absorb the water. The foam that was prepared with the buffer according to the invention was hydrophilic even without further addition of a foaming additive and retained its hydrophilicity even after washing intensively with water.

b) Usage without Glycerol (Comparison)

12.1 g of STP1 were dissolved in 3.4 g P/B 2.7. As a second reagent, a phosphate buffer was used. For this purpose, 9.078 g KH₂PO₄ were dissolved in 1000 mL of water, as a second solution 11.876 g Na₂HPO₄ were dissolved in 1000 mL of water. 150 mL of the Na₂HPO₄-solution were mixed with the KH₂PO₄-solution to give 1000 mL. The pH-value of this phosphate buffer was 6.1, the buffer concentration of this solution was 0.069 mol/L. The obtained buffer solution was adjusted to reach a viscosity of approximately 500 mPas with 66 g Walocel CRT 30G. 19 g Tegostab B 8408 was added to this buffer solution as a foaming aid. The buffer was used for the preparation of a foam without further dilution with glycerol as an aqueous component. The two components were separately filled in one chamber each of a 2K-spray apparatus that is powered by compressed air, the chambers of the spray apparatus being at a volume ratio of 2.5 (STP) to 1 (buffer solution) to each other. A synchronous application of both components at this volume ratio is ensured by design and was carried out by using a static mixer, in which the contents were thoroughly mixed. A completely cured foam was obtained after 0.5 minutes. The cured foam was hydrophilic, after drying at RT overnight. One drop of water was absorbed completely by the foam within 1 second. Afterwards this foam was washed for 5 minutes with running warm water (approximately 40° C.) and 10 minutes with running cold water (approximately 15 min). After drying, the drops-test with water showed that the foam needed 2 minutes to absorb the water completely. The very high hydrophilicity of the foam was partially lost, since the foaming aid was partially washed out.

1. A multi-component system comprising at least two separate components A and B, wherein component A comprises an alkoxysilane-terminated pre-polymer and component B comprises a mixture comprising a component B1 comprising water, and a component B2 comprising a polyol having at least two OH-groups and a molar mass ≧62 and ≦500 g/mol, wherein the content of component B2 within component B is >20 wt % and ≦80 wt %.

2. Multi-component system according to claim 1, wherein component B1 has a pH-value ≧3.0 and ≦9.0 at 20° C.

3. Multi-component system according to claim 1, wherein component B1 comprises at least one buffer system.

4. Multi-component system according to claim 3, wherein the buffer system is based on at least one organic carboxylic acid and its conjugate base.

5. Multi-component system according to claim 4, wherein the buffer system comprises acetic acid, succinic acid, tartaric acid, malic acid, or citric acid, or a combination thereof, and the respective conjugate base thereof.

6. Multi-component system according to claim 3, wherein the concentration of the buffer system in the component B1 is from 0.001 to 2.0 mol/L.

7. Multi-component system according to claim 1, wherein the polyol of component B2 comprises at least three OH-groups.

8. Multi-component system according to claim 7, wherein the polyol of component B2 is glycerol.

9. Multi-component system according to claim 1, wherein the content of component B2 in component B is ≧35 wt % and ≦75 wt %.

10. Multi-component system according to claim 1, wherein component A comprises an alkoxysilane-terminated polyurethane pre-polymer.

11. Multi-component system according to claim 10, wherein the alkoxysilane-terminated pre-polymer is obtained by reacting an alkoxysilane comprising at least one isocyanate-reactive group, with an isocyanate-terminated pre-polymer.

12. Multi-component system according to claim 10, wherein the alkoxysilane-terminated polyurethane pre-polymer is based on a polyester polyol and/or polyether polyol, wherein the proportion of ethylene oxide units in the polyether polyol is ≦50 wt %.

13. Multi-component system according to claim 1, wherein the alkoxysilane-terminated pre-polymer comprises at least one α-silane group.

14. A shaped object obtainable by polymerization of a multi-component system according to claim 1.

15. A multi-chamber pressure cell with an outlet valve and a mixing nozzle, comprising a multi-component system according to claim 1, wherein components A and B of the multi-component system are charged separately in a first and a second chamber of the multi-chamber pressure cell, and the first and/or the second chamber each are provided with a propellant gas under elevated pressure, wherein the propellant gas of the first and second chambers is the same or different.
